(19) United States
(12) Patent Application Publication
(10) Pub. No.: US 2006/0226785 A1
(43) Pub. Date: Oct. 12, 2006

(54) Backlight assemblies, connector modules and conductive blocks thereof

(75) Inventors: Yu-Chuan Lin, Hunei Township (TW); Hui-Kai Chou, Taipei City (TW); Yi-Shiuan Tsai, Kaohsiung City (TW); Chih-Sung Wang, Jhubei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: AU Optronics Corp.

(21) Appl. No.: 11/247,556

(22) Filed: Oct. 11, 2005

(30) Foreign Application Priority Data
Apr. 8, 2005 (TW) 94111140

(51) Int. Cl. H01J 31/26

(52) U.S. Cl. 315/10

(57) ABSTRACT

Backlight assemblies for large flat panel displays are provided. A backlight assembly comprises a back plate, a plurality of first and second lamps, a first connector module and an optical assembly. The first and second lamps are parallel to an axis, disposed in a first position and a second position of the axis, respectively. The first connector module is disposed on the back plate, comprising a plurality of conductive blocks. Each conductive block comprises an insulator, a first conductive member and a second conductive member disposed on opposite sides of the insulation body. A protrusion is formed in the middle of the insulator to support the optical assembly. The first and second conductive members both have depressions to receive and electrically connect the first and second lamps.

### BACKGROUND

The invention relates in general to backlight assemblies and in particular to backlight assemblies for large flat panel displays.

Referring to FIG. 1a, a conventional backlight assembly comprises a back plate B and a plurality of parallel lamps L disposed thereon, such as Cold Cathode Fluorescent Lamps (CCFLs) or External Electrode Fluorescent Lamps (EEFLs). In some large backlight assemblies (over 17 inches), lamps L may not provide required length for sufficient illumination. Moreover, with progressive extension of lamps L, deformation from gravity becomes serious, adversely affecting uniformity of illumination.

As shown in FIG. 1b, another conventional backlight assembly comprises several lamps L of different lengths. However, arrangement of the lamps L and corresponding drive circuits is complex, potentially increasing production costs.

### SUMMARY

Backlight assemblies for large flat panel displays are provided. A backlight assembly comprises a back plate, a plurality of first and second lamps, a first connector module and an optical assembly. The first and second lamps are parallel to an axis, disposed in a first position and a second position of the axis, respectively. The first connector module is disposed on the back plate, comprising a plurality of conductive blocks. Each conductive block comprises an insulator, a first conductive member and a second conductive member disposed on opposite sides of the insulation body. A protrusion is formed in the middle of the insulator to support the optical assembly. The first and second conductive members both have depressions to receive and electrically connect the first and second lamps.

### DESCRIPTION OF THE DRAWINGS

FIG. 1a is a perspective diagram of a conventional backlight assembly;

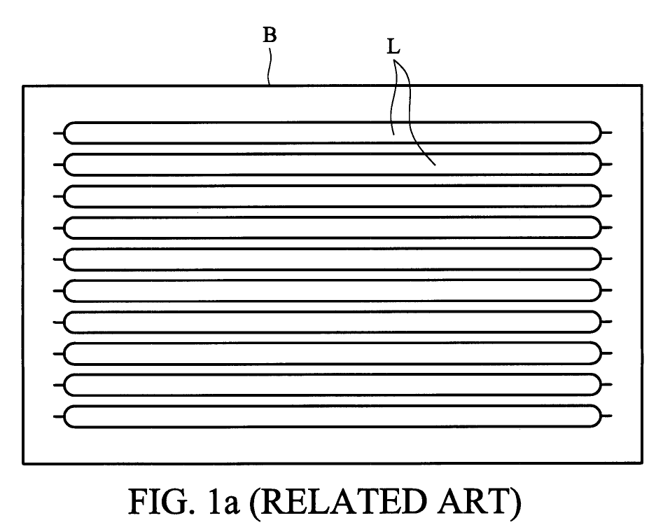

FIG. 1b is a perspective diagram of another conventional backlight assembly;

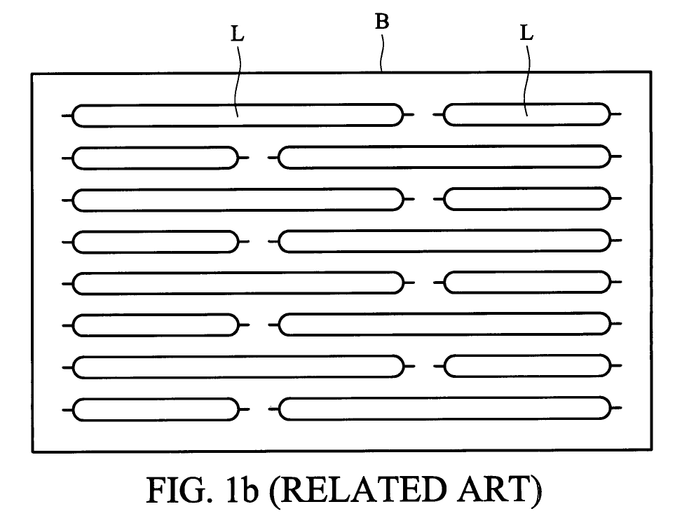

FIG. 2 is a perspective diagram of an embodiment of a backlight assembly;

FIG. 3a is a perspective diagram of an embodiment of another backlight assembly;

FIG. 3b is a perspective diagram of a first connector module connecting the first and second lamps;

FIG. 4 is a perspective diagram of another backlight assembly;

FIG. 5 is a perspective diagram of another backlight assembly;

FIG. 6 is a perspective diagram of another backlight assembly;

FIG. 7a is an exploded diagram of a conductive block;

FIG. 7b is an exploded diagram of another conductive block;

FIG. 7c is a sectional view along A-A′ of the conductive block in FIG. 7b;

FIG. 7d is a perspective diagram of two conductive blocks connected along X axis; and

FIG. 7e is a perspective diagram of four conductive blocks connected along X axis and Y axis.

### DETAILED DESCRIPTION

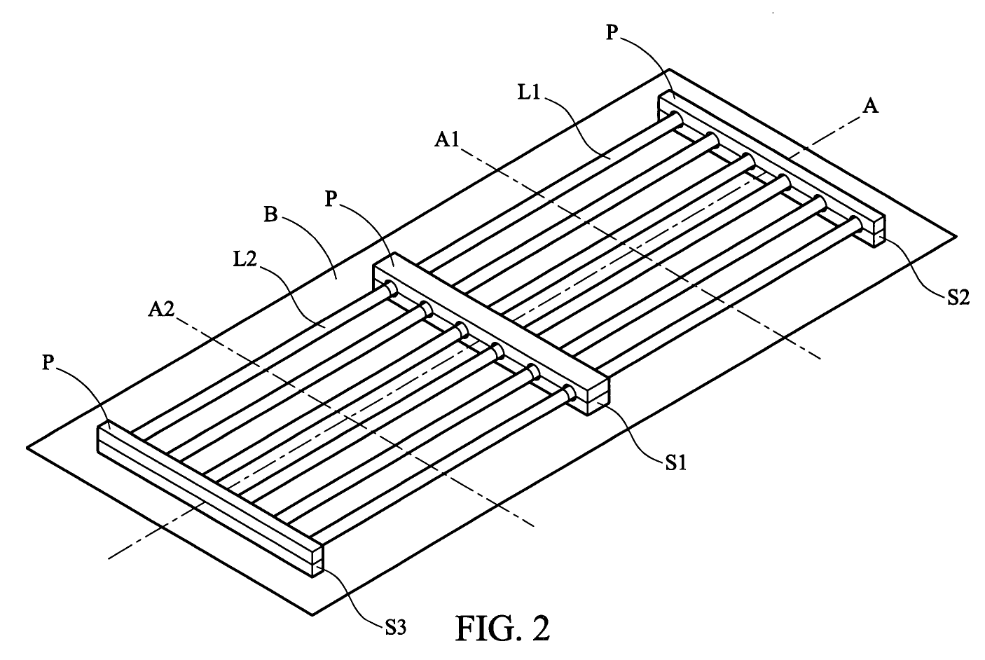

Referring to FIG. 2, an embodiment of a direct type backlight assembly for a large flat panel display primarily comprises a back plate B, a first connector module S1, a second connector module S2, a third connector module S3, a plurality of first lamps L1 and second lamps L2. As shown in FIG. 2, the first and second lamps L1 and L2 are parallel to axis A, situated in a first position A1 and a second position A2 of axis A respectively and sustained by the first, second and third connectors S1, S2 and S3. Optical assemblies (not shown), such as diffuser films or other optical films, are disposed on the backlight assembly. The lamps L1 and L2 emit light through the optical assemblies to form a planar emitting surface.

Specifically, electrodes of the lamps L1 and L2 are electrically connected via the first, second and third connectors S1, S2 and S3. In some embodiments, the backlight assembly further comprises a plurality of supporters P disposed on the first, second and third connector modules S1, S2 and S3 as shown in FIG. 2, to support the optical assemblies and protect the lamps L1 and L2.

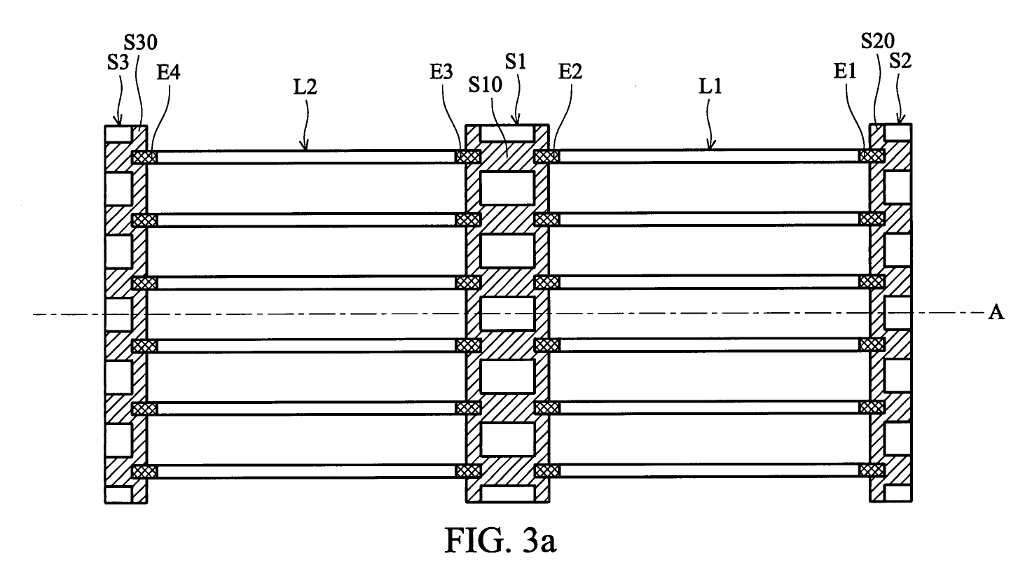

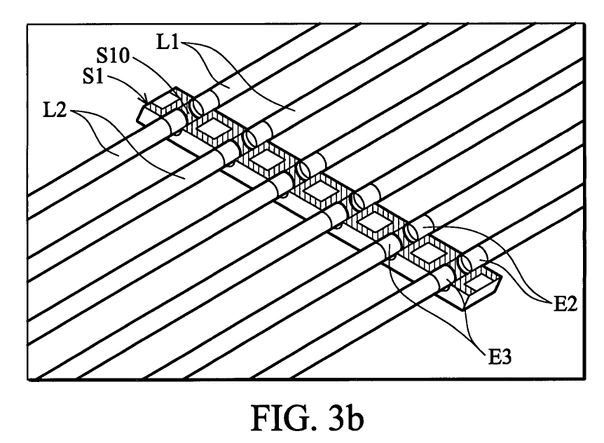

Referring to FIG. 3a, an embodiment of the first and second lamps L1 and L2 are substantially perpendicular to the first, second and third connectors S1, S2 and S3. Each of the first lamps L1 has a first electrode E1 and a second electrode E2, and each of the second lamps L2 has a third electrode E3 and a fourth electrode E4. As shown in FIGS. 3a and 3b, the first connector S1 has a first connecting portion S10 electrically connecting the second and third electrodes E2 and E3 of the lamps L1 and L2. Moreover, the second connector S2 has a second connecting portion S20 electrically connecting the first electrodes E1 of lamps L1, and the third connector S3 has a third connecting portion S30 electrically connecting the fourth electrodes E4 of lamps L2, respectively.

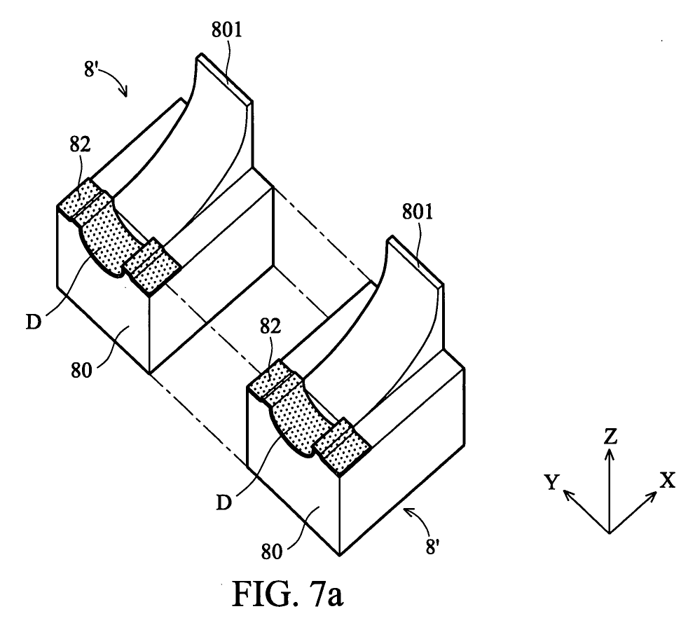

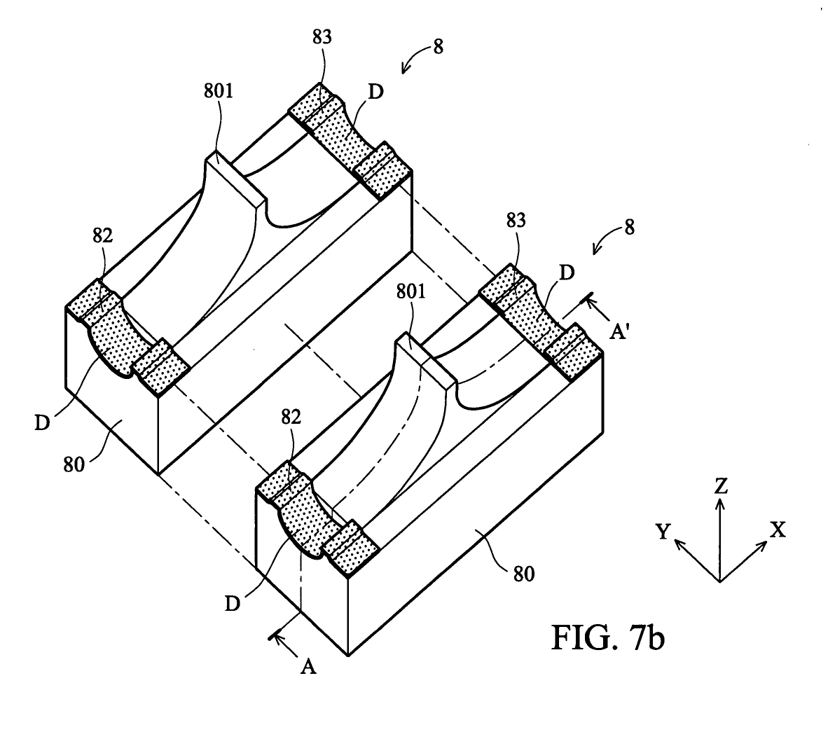

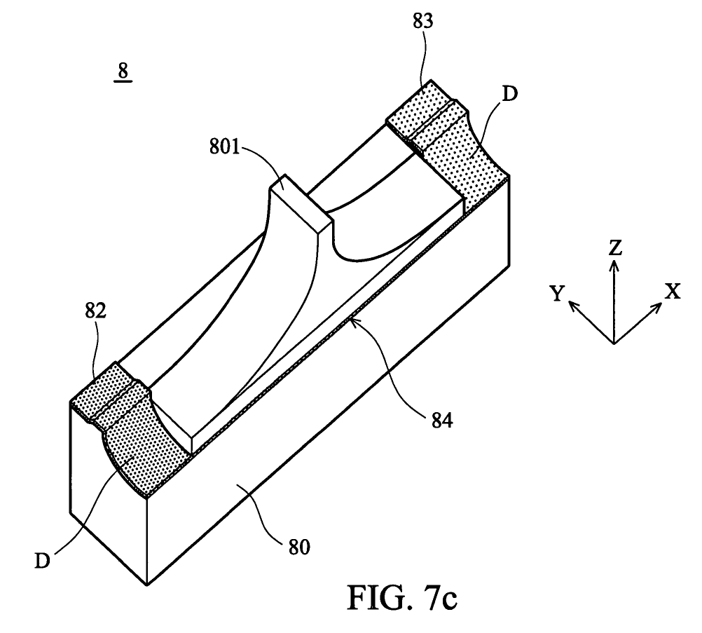

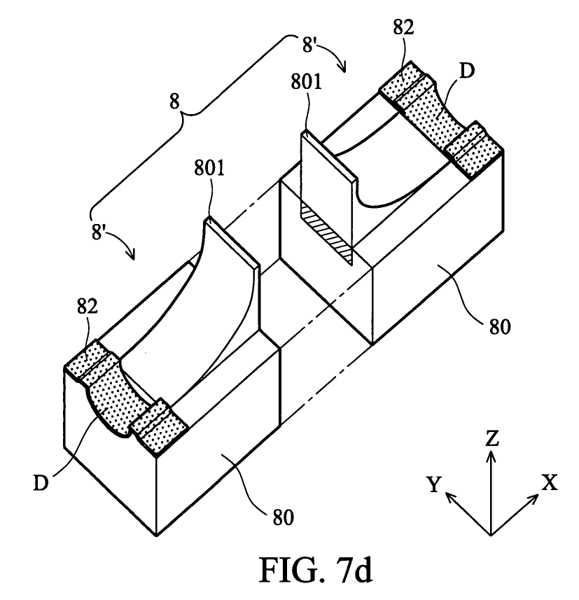

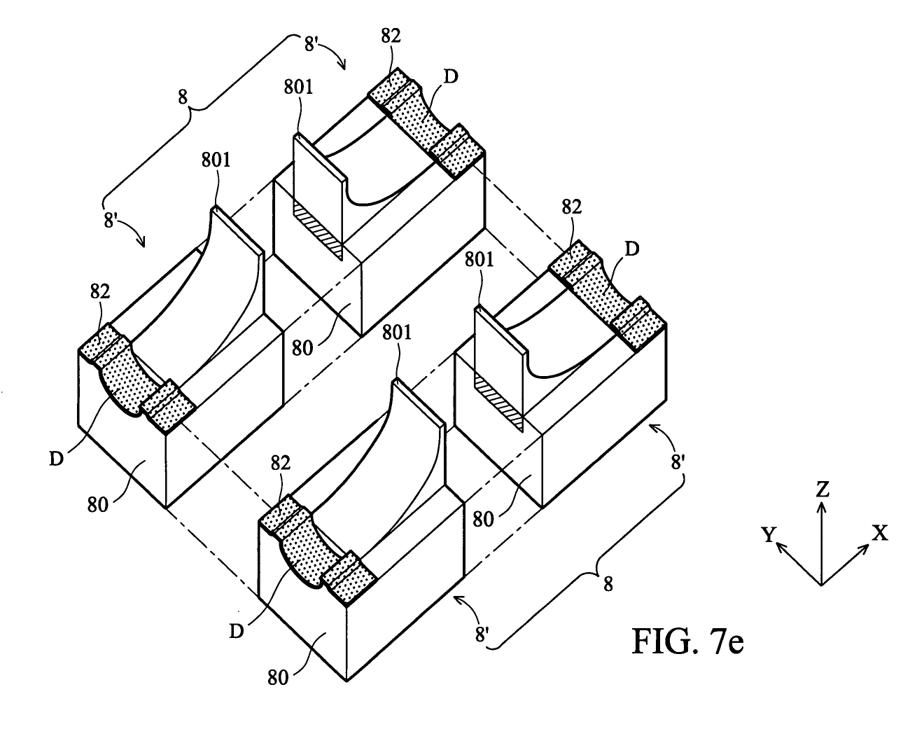

An embodiment of the second and third connector modules S2 and S3 in FIG. 3a can constitute several conductive blocks 8′ as shown in FIG. 7a. Each conductive block 8′ depicted in FIG. 7a comprises a conductive member 82. The conductive members 82 on conductive blocks 8′ can be connected substantially along Y axis, to form the second and third connecting portions S20 and S30 in FIG. 3a.

An embodiment of the first connector module S1 in FIG. 3a can constitute several conductive blocks 8 as shown in FIG. 7b. Each conductive block 8 depicted in FIG. 7b comprises a pair of conductive members 82 and 83 electrically connected to each other along X axis. The first and second conductive members 82 and 83 can be further connected substantially along Y axis, to form the first connecting portion S10 in FIG. 3a.

In some embodiments, the first and second lamps L1 and L2 are External Electrode Fluorescent Lamps (EEFLs), and the first, second and third connector modules S1, S2 and S3 can be alternatively connected to ground or power source.

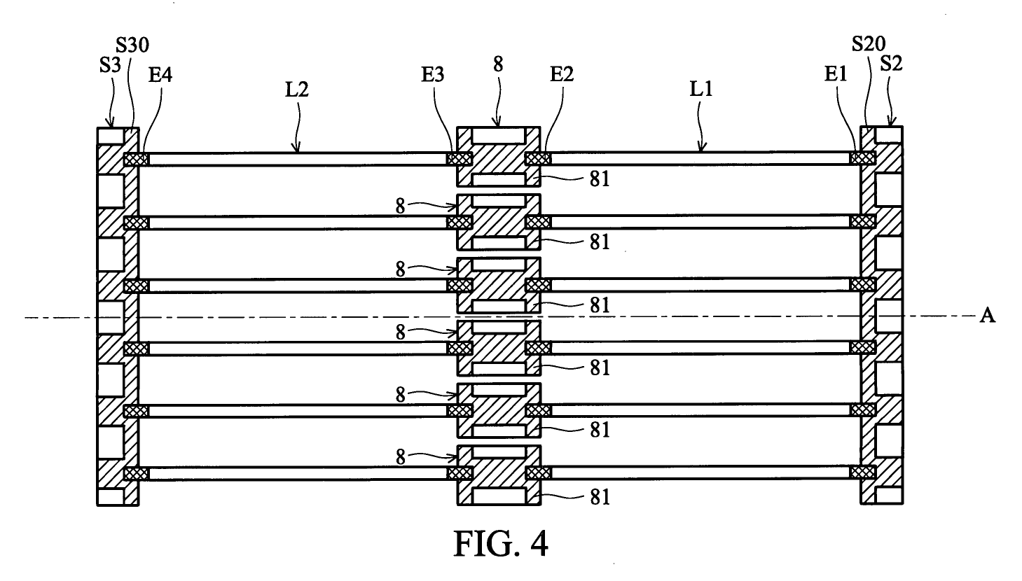

Referring to FIG. 4, another embodiment of a backlight assembly comprises a plurality of conductive blocks 8, replacing the first connector module S1 shown in FIG. 3a. With respect to FIG. 4, each conductive block 8 comprises a conductive portion 81 to connect a second electrode E2 of a first lamp L1 and a third electrode E3 of a second lamp L2.

A detailed structure of the conductive block 8 is depicted in FIG. 7b, wherein each conductive block 8 comprises a pair of conductive members 82 and 83 connected to each other, forming the conductive portion 81 in FIG. 4. Specifically, since each conductive block 8 merely connects a second electrode E2 and a third electrode E3 along A axis, adjacent second and third electrodes E2 and E3 arranged perpendicular to axis A are electrically independent. In some embodiments, the first and second lamps L1 and L2 are External Electrode Fluorescent Lamps (EEFLs), and the first and third connector modules S1 and S3 can be alternatively connected to ground or power source.

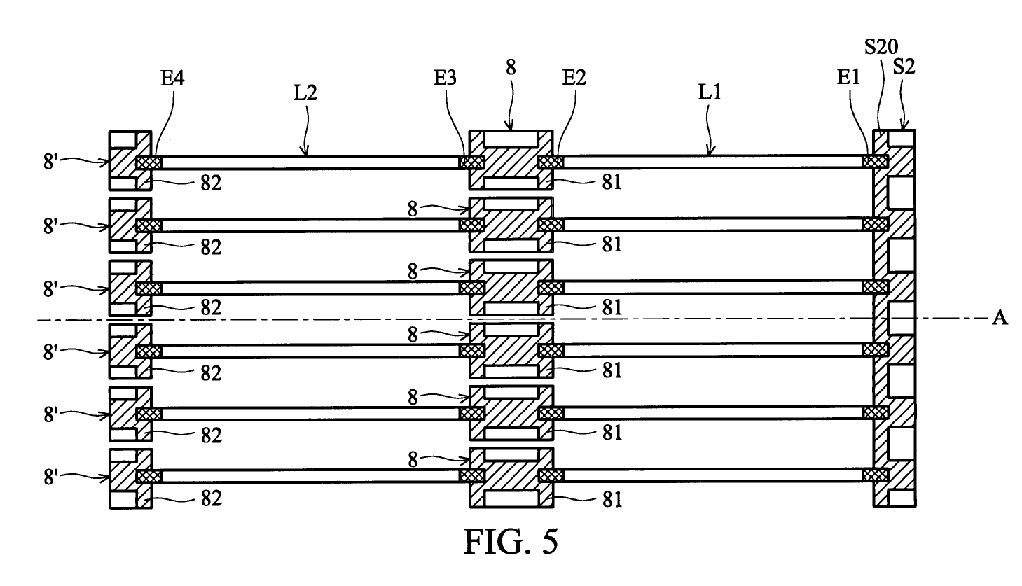

Referring to FIG. 5, another embodiment of a backlight assembly comprises a plurality of conductive blocks 8′, replacing the third connector module S3 in FIG. 4. A detailed structure of conductive block 8′ is depicted in FIG. 7a, wherein each conductive block 8′ comprises a conductive member 82, connecting a fourth electrode E4 to external circuits, as shown in FIG. 5. Specifically, since the conductive blocks 8′ are separately arranged, the fourth electrodes E4 are electrically independent. In some embodiments, the first and second lamps L1 and L2 can be Cold Cathode Fluorescent Lamps (CCFLs) or External Electrode Fluorescent Lamps (EEFLs). In some embodiments, the fourth electrodes E4 are respectively connected to power source, and the first electrodes E1 are connected to common ground via the second connecting portion S20, thus potentially simplifying electrical circuits and reducing production costs.

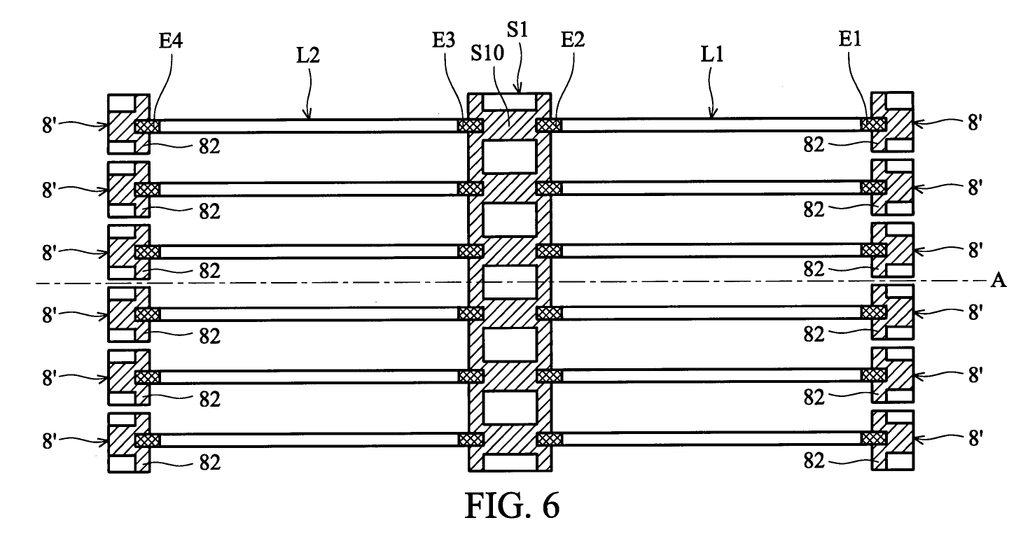

Referring to FIG. 6, another embodiment of a backlight assembly comprises a plurality of conductive blocks 8′, replacing the second and third connectors S2 and S3 in FIG. 3a. With respect to FIG. 6, the second and third electrodes E2 and E3 are electrically connected via the first connecting portion S10 of the first connector module S1. The conductive blocks 8′ individually connect the first electrodes E1 or the fourth electrodes E4 to external circuits. Since the conductive blocks 8′ are separately arranged, adjacent first and fourth electrodes E1 and E4 are electrically independent.

In some embodiments, the first and second lamps L1 and L2 can be Cold Cathode Fluorescent Lamps (CCFLs) or External Electrode Fluorescent Lamps (EEFLs). In some embodiments, the first and fourth electrodes E1 and E4 are connected to power source, and the first connecting portion S10 connects to common ground, thereby potentially simplifying electrical circuits and reducing production costs.

A detailed structure of the conductive block 8′ is depicted in FIG. 7a. With respect to FIG. 7a, a plurality of rectangular conductive blocks 8′ can be connected along Y axis to form the second connector module S2 or the third connector module S3 in FIG. 3a. Specifically, the conductive members 82 can be connected to form the second connecting portion S20 or the third connecting portion S30 as shown in FIG. 3a. However, the conductive blocks 8′ can also be separately arranged along Y axis, being electrically independent from each other to individually connect the first and fourth electrodes E1 and E4 to external circuits as shown in FIG. 6.

In FIG. 7a, each conductive block 8′ comprises an insulator 80 and a conductive member 82 connected thereto. Each conductive member 82 has a depression D to receive and electrically connect an electrode of a lamp. Specifically, the insulator 80 comprises a protrusion 801 projecting along Z axis, opposite to the conductive member 82. During assembly, the insulator 80 is disposed on the back plate B, and the protrusion 801 directly supports the optical assemblies (not shown). In some embodiments, the insulator 80 may comprise plastic or other insulating materials, and the conductive member 82 can be metal or other material of high conductivity.

Referring to FIG. 7b, a plurality of rectangular conductive blocks 8 are connected along Y axis, to form the first connector module S1 for connection of the second and third electrodes E2 and E3 as shown in FIG. 3a. Each conductive block 8 comprises an insulator 80, a pair of conductive members 82 and 83 mounted on both sides of the insulator 80. Each of the conductive members 82 and 83 has a depression D to receive and electrically connect an electrode of a lamp. Specifically, the insulator 80 comprises a protrusion 801 in the middle thereof, projecting along Z axis to directly support the optical assemblies (not shown). The insulator 80 may comprise plastic or other insulating material, and the conductive members 82 and 83 can be metal or other material of high conductivity.

In some embodiments, the conductive blocks 8 can also be separately arranged along Y axis (as shown in FIGS. 4 and 5), each individually connecting a pair of second and third electrodes E2 and E3 of the first and second lamps L1 and L2, such that adjacent electrodes E2 and E3 arranged perpendicular to A axis are electrically independent.

Referring to FIG. 7c, an embodiment of the conductive block 8 further comprises a connecting element 84 electrically connecting the conductive members 82 and 83, to form the conductive portion 81 in FIGS. 4 and 5. With respect to FIG. 7b, each conductive block 8 is integrally formed, however, each can also constitute two conductive blocks 8′ back to back along X axis as shown in FIG. 7d. Referring to FIG. 7e, at least four conductive blocks 8′ can also connect to each other along X axis and Y axis, to form the first connector module S1 in FIG. 3a.

Backlight assemblies, connector modules and conductive blocks are provided according to the embodiments. Various connector modules can be formed by the conductive blocks 8′ along X and Y axes as shown in FIGS. 7a and 7e, or merely by the conductive blocks 8 of FIG. 7b along Y axis. With appropriate arrangements of the connector modules and the conductive blocks, drive circuits of the backlight assemblies can be potentially simplified, especially for large flat panel displays.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. A conductive block, comprising:
an insulator having a protrusion; and
a first conductive member disposed on a first side of the insulator.

2. The conductive block as claimed in claim 1, wherein the protrusion is disposed on a second side of the insulator, opposite to the first conductive member.

3. The conductive block as claimed in claim 1, further comprising a second conductive member, wherein the second conductive member is disposed on a second side of the insulator, opposite to the first conductive member, and the protrusion is disposed in the middle of the insulator.

4. The conductive block as claimed in claim 3, further comprising a connecting element electrically connecting to the first and second conductive members.

5. The conductive block as claimed in claim 3, wherein the first conductive member comprises a first depression, and the second conductive member comprises a second depression.

6. A connector module, comprising:
a plurality of conductive blocks connected along a first direction, each of the conductive blocks comprising an insulator and a first conductive member disposed on a first side thereof, wherein the insulator comprises a protrusion, and the first conductive members are electrically connected.

7. The connector module as claimed in claim 6, wherein the protrusion is disposed on a second side of the insulator, opposite to the first side of the insulator.

8. The connector module as claimed in claim 6, each of the conductive blocks further comprising a second conductive member disposed on a second side of the insulator opposite to the first side, wherein the second conductive members are electrically connected, and the protrusion is disposed in the middle of the insulator.

9. The connector module as claimed in claim 8, wherein each of the conductive blocks further comprises a connecting element electrically connecting to the first and second conductive members.

10. The connector module as claimed in claim 9, wherein the first conductive member comprises a first depression, and the second conductive member comprises a second depression.

11. A backlight assembly, comprising:
a back plate;
a plurality of first lamps parallel to an axis, disposed in a first position of the axis;
a plurality of second lamps parallel to the axis, disposed in a second position of the axis and different from the first position;
a first connector module comprising a plurality of first conductive blocks, each of the first conductive blocks comprising a first insulator, a first conductive member and a second conductive member, the first insulator having a first protrusion, the first conductive member having a first depression, the second conductive member having a second depression, wherein the first and second depressions are disposed on opposite sides of the first insulator, respectively; and
an optical assembly disposed on the protrusions.

12. The backlight assembly as claimed in claim 11, wherein each of the first conductive blocks further comprises a connecting element electrically connecting to a pair of the first and second conductive members.

13. The backlight assembly as claimed in claim 12, wherein the first and second conductive members are electrically connected.

14. The backlight assembly as claimed in claim 11, further comprising a second connector module and a third connector module, each of the first lamps comprising a first electrode and a second electrode, each of the second lamps comprising a third electrode and a fourth electrode, wherein the first connector module electrically connects to the second and third electrodes, the second connector module electrically connects to the first electrodes, and the third connector module electrically connects to the fourth electrodes.

15. The backlight assembly as claimed in claim 14, wherein the second connector module comprises a plurality of second conductive blocks, each of the second conductive blocks comprising an second insulator and a third conductive member disposed on a side of the second insulator, wherein the second insulator comprises a second protrusion, and the third conductive member comprises a third depression adapted to electrically connect to the first electrode.

16. The backlight assembly as claimed in claim 15, wherein the third conductive members are electrically connected.

17. The backlight assembly as claimed in claim 15, wherein the third connector module comprises a plurality of third conductive blocks, each of the third conductive blocks comprising a third insulator and a fourth conductive member disposed on a side of the third insulator, wherein the third insulator comprises a third protrusion, and the fourth conductive member comprises a fourth depression adapted to electrically connect to the fourth electrode.

18. The backlight assembly as claimed in claim 15, wherein the fourth conductive members are electrically connected.

19. The backlight assembly as claimed in claim 11, wherein the first and second lamps are cold cathode fluorescent lamps or external electrode fluorescent lamps.

20. The backlight assembly as claimed in claim 11, wherein the optical assembly comprises a diffuser or an optical film.
